(19) United States
(12) Patent Application Publication
(10) Pub. No.: US 2022/0301317 A1
(43) Pub. Date: Sep. 22, 2022

(54) METHOD AND DEVICE FOR CONSTRUCTING OBJECT MOTION TRAJECTORY, AND COMPUTER STORAGE MEDIUM

(71) Applicant: SHENZHEN SENSETIME TECHNOLOGY CO., LTD., Shenzhen (CN)

(72) Inventors: Hao FU, Shenzhen (CN); Weilin LI, Shenzhen (CN); Xiaotong LI, Shenzhen (CN); Yinyan ZHANG, Shenzhen (CN); Hui LIU, Shenzhen (CN)

(21) Appl. No.: 17/836,288

(22) Filed: Jun. 9, 2022

Related U.S. Application Data
(63) Continuation of application No. PCT/CN2020/100265, filed on Jul. 3, 2020.

(30) Foreign Application Priority Data
Dec. 30, 2019 (CN) 201911402892.7

(51) Int. Cl. G06V 20/52; G06T 7/246; G06V 20/40

(52) U.S. Cl. CPC G06V 20/52; G06T 7/246; G06V 20/46; G06T 2207/30241

(57) ABSTRACT

A method and device for constructing object motion trajectory, and a computer readable storage medium are provided. The method for constructing object motion trajectory includes that: at least two different types of object features matching with a search condition are acquired, the at least two different types of object features including at least two of face features, body features or vehicle features; photographing time points and photographing places that are respectively associated with the at least two different types of object features are acquired; and an object motion trajectory is generated according to a combination of the photographing time points and the photographing places that are respectively associated with the at least two different types of object features.

### CROSS-REFERENCE TO RELATED APPLICATIONS

This is a continuation of International Patent Application No. PCT/CN2020/100265, filed on Jul. 3, 2020, which claims priority to Chinese Patent Application No. 201911402892.7, filed to the China National Intellectual Property Administration on Dec. 30, 2019 and entitled “Object Motion Trajectory Construction Method and Device, and Computer Storage Medium”. The disclosures of International Patent Application No. PCT/CN2020/100265 and Chinese Patent Application No. 201911402892.7 are hereby incorporated by reference in their entireties.

### BACKGROUND

At present, many camera sites have been established in cities, and real-time videos including various contents such as bodies, faces, motor vehicles and non-motor vehicles may be captured. With object detection and structural analysis on these videos, feature and attribute information on the faces, bodies and vehicles may be extracted. When the police department performs daily video investigation, suspect tracking and other tasks, there is typically a need to upload picture and text clues collected from various channels and having suspect relevant information (e.g., including the face, body, crime/escape vehicle and the like). The clues are then compared with contents in the real-time videos, such that an action route, escape trajectory and the like of the suspect may be restored by searching results having spatio-temporal information.

### SUMMARY

The disclosure relates to the field of traffic monitoring, and more particularly, to a method and device for constructing object motion trajectory, and a non-transitory computer readable storage medium.

The disclosure provides a method for constructing object motion trajectory, which includes the following operations.

At least two different types of object features matching with a search condition are acquired. The at least two different types of object features include at least two of face features, body features or vehicle features.

Photographing time points and photographing places that are respectively associated with the at least two different types of object features are acquired.

An object motion trajectory is generated according to a combination of the photographing time points and the photographing places that are respectively associated with the at least two different types of object features.

The disclosure provides a device for constructing object motion trajectory. The device includes a processor and a memory for storing a computer program. The processor is configured to execute the computer program to: acquire at least two different types of object features matching with a search condition, the at least two different types of object features comprising at least two of face features, body features or vehicle features; acquire photographing time points and photographing places that are respectively associated with the at least two different types of object features; and generate an object motion trajectory according to a combination of the photographing time points and the photographing places that are respectively associated with the at least two different types of object features.

The disclosure provides a non-transitory computer readable storage medium having stored therein a computer program which, when being executed by a processor, causes the processor to implement operations comprising: acquiring at least two different types of object features matching with a search condition, the at least two different types of object features comprising at least two of face features, body features or vehicle features; acquiring photographing time points and photographing places that are respectively associated with the at least two different types of object features; and generating an object motion trajectory according to a combination of the photographing time points and the photographing places that are respectively associated with the at least two different types of object features.

### BRIEF DESCRIPTION OF THE DRAWINGS

In order to describe the technical solutions in the embodiments of the disclosure more clearly, a simple introduction on the accompanying drawings which are needed in the description of the embodiments is given below. It is apparent that the accompanying drawings in the description below are merely some of the embodiments of the disclosure, based on which other drawings may be obtained by those of ordinary skill in the art without any creative effort.

FIG. 1 is a flowchart diagram illustrating a first embodiment of a method for constructing object motion trajectory provided by the disclosure.

FIG. 2 is a flowchart diagram illustrating a second embodiment of a method for constructing object motion trajectory provided by the disclosure.

FIG. 3 is a flowchart diagram illustrating a third embodiment of a method for constructing object motion trajectory provided by the disclosure.

FIG. 4 is a flowchart diagram illustrating a fourth embodiment of a method for constructing object motion trajectory provided by the disclosure.

FIG. 5 is a structural schematic diagram illustrating an embodiment of a device for constructing object motion trajectory provided by the disclosure.

FIG. 6 is a structural schematic diagram illustrating another embodiment of a device for constructing object motion trajectory provided by the disclosure.

FIG. 7 is a structural schematic diagram illustrating an embodiment of a computer readable storage medium provided by the disclosure.

### DETAILED DESCRIPTION

The technical solutions in the embodiments of the disclosure will be clearly and completely described hereinafter with the drawings in the embodiments of the disclosure. It is apparent that the described embodiments are only part of the embodiments of the disclosure, not all of the embodiments. All other embodiments obtained by those of ordinary skill in the art based on the embodiments of the disclosure without creative efforts shall fall within the scope of protection of the disclosure.

The disclosure provides a method for constructing object motion trajectory. Based on the development of the face search, body search, vehicle search and video structurization technologies, a variety of algorithms are integrated in the method provided by the disclosure. The method automatically searches results at a time for face information, body information, vehicle information and other single search objects or a combination of multiple search objects in traffic images, and merges and restores all object motion trajectories.

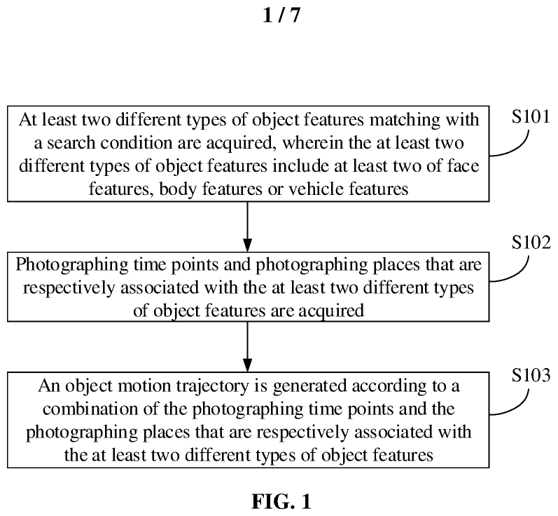

Specifically, referring to FIG. 1, FIG. 1 is a flowchart of a first embodiment of a method for constructing object motion trajectory provided by the disclosure. The method for constructing object motion trajectory provided by the disclosure is applied to a device for constructing object motion trajectory. The device for constructing object motion trajectory may be a terminal device such as a smartphone, a tablet, a notebook, a computer or a wearable device, and may also be a monitoring system in a checkpoint traffic system. In following descriptions of the embodiments, the device for constructing trajectory is used to describe the method for constructing object motion trajectory.

As shown in FIG. 1, the method for constructing object motion trajectory provided by the embodiment specifically includes the following operations.

In S101, at least two different types of object features matching with a search condition are acquired, the at least two different types of object features including at least two of face features, body features or vehicle features.

The device for constructing trajectory acquires multiple image data. The image data may be directly acquired from the existing traffic big data open source platform or the traffic management department. The image data include time information and position information. The device for constructing trajectory may further acquire a real-time video stream from the existing traffic big data open source platform or the traffic management department, and then performs image frame segmentation on the real-time video stream to acquire the multiple image data.

Specifically, the image data may include checkpoint site position information in the monitoring region, such as latitude and longitude information, and may further include record data of passing vehicles captured by the checkpoint within a preset time period such as one month. The record data of passing vehicles captured by the checkpoint includes time information. If the record data of passing vehicles captured by the checkpoint includes the position information such as the latitude and the longitude information, the checkpoint site position information may also be directly extracted from the record data of passing vehicles captured by the checkpoint.

In an extreme case, the capturing record in recent period of time cannot ensure all checkpoint sites have image data. In order to ensure that all checkpoint sites in the monitoring region are acquired, the terminal device may acquire all checkpoint site position information from the existing traffic big data open source platform or the traffic management department.

The original image data set may have a part of abnormal data, and the terminal device may further preprocess the image data after acquiring the image data. Specifically, the terminal device determines whether each image data includes time information of capturing time and position information including the latitude and longitude information. If the image data lacks either the time information or the position information, the terminal device removes the corresponding image data so as to prevent a data missing problem in a subsequent spatio-temporal prediction library.

The terminal device cleans repeated data and invalid data in the original image data, which is helpful for data analysis.

The device for constructing trajectory respectively performs object detection on the multiple image data. Specifically, the device for constructing trajectory detects all faces, bodies and/or vehicles in the image data through an object detection algorithm or integration of multiple object detection algorithms, and extracts features of all the faces, bodies and/or vehicles to form the object features.

Specifically, the object feature may include an image feature extracted from the image data and/or a text feature generated by performing structural analysis on the image feature. The image feature includes all face features, body features and vehicle features in the image data, and the text feature is feature information generated by performing the structural analysis on the vehicle feature. For example, the device for constructing trajectory may perform text recognition on the vehicle feature to obtain a license plate number in the vehicle feature, and determine the license plate number as the text feature.

Further, the device for constructing trajectory receives a search condition input by the user, and searches, according to the search condition, object features matching with the search condition from a dynamic database. The device for constructing trajectory acquires at least two different types of object features matching with the search condition, and the at least two different types of object features include at least two of face features, body features or vehicle features. The acquisition for multiple types of object features is beneficial to extracting enough trajectory information, so as to avoid losing a part of important trajectory information due to photographing blur, obstacle blocking and other reasons, and to improve the accuracy of the method for constructing trajectory.

The search condition may be a face and body image, a crime/escape vehicle image and the like of a search object that are acquired by the police via site investigation, reporting of a police station, capture and search, or any image or text including the above image information.

For example, after the police inputs the face and body image of the suspect into the device for constructing trajectory, the device for constructing trajectory searches, according to the face and body image, object features matching with the face and body image from the dynamic database.

In S102, photographing time points and photographing places that are respectively associated with the at least two different types of object features are acquired.

After acquiring the object feature of the image data, the device for constructing trajectory may further acquire the photographing time point and the photographing place of the image data, and associates the object feature of the same image data with the corresponding photographing time point and photographing place. The association may be implemented by storing in a same storage space, and may also be implemented by setting a same identification number and the like.

Specifically, the device for constructing trajectory acquires the photographing time point of the object feature from the time information of the image data, and the device for constructing trajectory acquires the photographing place of the object feature from the position information of the image data.

The device for constructing trajectory further stores the associated object feature, the photographing time point and photographing place to the dynamic database. The dynamic database may be provided in a server, may also be provided in a local memory, and may further be provided in a cloud terminal.

In S103, an object motion trajectory is generated according to a combination of the photographing time points and the photographing places that are respectively associated with the at least two different types of object features.

The device for constructing trajectory extracts, from the dynamic database, the photographing time points and the photographing places respectively associated with the object features matching with the search condition, and links the photographing places according to a sequence of the object features (i.e., a sequence of the photographing time points) to generate the object motion trajectory.

In the embodiment, the device for constructing object motion trajectory acquires at least two different types of object features matching with a search condition, the at least two different types of object features including at least two of face features, body features or vehicle features; acquires photographing time points and photographing places that are respectively associated with the at least two different types of object features; and generates an object motion trajectory according to a combination of the photographing time points and the photographing places that are respectively associated with the at least two different types of object features. With the above method, the search condition is inputted to match the corresponding object features, and the object motion trajectory is generated according to the photographing time points and the photographing places that are respectively associated with the object features. Therefore, the practicability of the method for constructing object motion trajectory is improved.

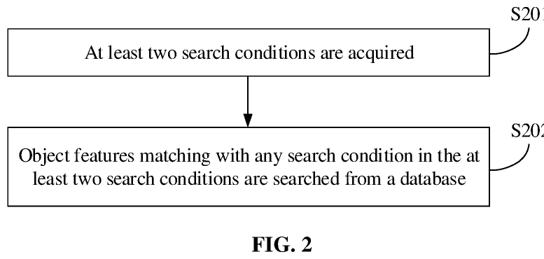

On the basis of operation S101 in the above embodiment, the disclosure further provides another specific method for constructing object motion trajectory. Specifically, referring to FIG. 2, FIG. 2 is a flowchart of a second embodiment of a method for constructing object motion trajectory provided by the disclosure.

As shown in FIG. 2, the method for constructing object motion trajectory provided by the embodiment may specifically include the following operations.

In S201, at least two search conditions are acquired.

The at least two search conditions in the disclosure may include at least two conditions in a face search condition, a body search condition or a vehicle search condition. Based on the above types of the search conditions, the disclosure further provides corresponding search manners.

Specifically, when the device for constructing trajectory acquires one image data, and determines any object or a combination of the objects, such as the face, body, vehicle and the like as the search condition, types of search algorithms automatically called by the device for constructing trajectory are respectively as follows.

| Object/object | |
|---|---|
| combination | Search manner |
| Face | Face search, and face-body integrated search |
| Body | Body integrated search |
| Vehicle | Vehicle search |
| Face + body | Face search, and body integrated search |
| Face + vehicle | Face search, face integrated search, and |
| | vehicle search |
| Body + vehicle | Body integrated search, and vehicle search |
| Face + body + vehicle | Face search, body integrated search, and |
| | vehicle search |

Further, the search condition may further include an identity search condition. The object feature is associated with identity information in advance, the identity information being any one of identity card information, name information or archival information.

In S202, object features matching with any search condition in the at least two search conditions are searched from a database.

When searching the required object features in the dynamic database, the device for constructing trajectory respectively matches the object features with at least two search conditions input by the user, and selects object features matching with any search condition in the at least two search conditions.

For example, when two search conditions input by the user are respectively the face search condition and the vehicle search condition, the device for constructing trajectory searches in the dynamic database based on the face search condition and the vehicle search condition, and extracts object features matching with at least one search condition in the face search condition and the vehicle search condition, thereby implementing multi-dimension search on the object features, and avoiding the trajectory point missing problem due to the single-dimension search.

The face search manner based on the face search condition is specifically implemented as follows. A face in an image uploaded by the user is compared with faces in the object features in the dynamic database, and object features having a similarity more than a set threshold are returned. The integrated search manner based on the face search condition and the body search condition is specifically implemented as follows. A face or a body in an image uploaded by the user is compared with faces or bodies in the object features in the dynamic database, and object features having a similarity more than a set threshold are returned. The vehicle search manner based on the vehicle search condition is specifically implemented as follows. A vehicle in an image uploaded by the user is compared with vehicles in the object features in the dynamic database, and object features having a similarity more than a set threshold are returned. The vehicle search manner may also be implemented as follows. License plate numbers structurally extracted from the dynamic database are searched for based on a license plate number input by the user, and object features corresponding to the license plate number are returned. The face search manner based on the face search condition is specifically implemented as follows. The user inputs any one of identity card information, name information or archival information, and object features associated with corresponding identity information are matched based on the above information. For example, when the police needs to run after the criminal suspect, the police may input identity recognition information of the criminal suspect into the device for constructing trajectory. The identity recognition information may be any one of an archival Identifier (ID), a name, an identity card or a license plate number.

Specifically, the device for constructing trajectory determines a sample feature of any search condition in the at least two search conditions input by the user as a clustering center, clusters object features in the database, and determines object features within a preset range of the clustering center as the object features matching with the search condition.

In the embodiment, the device for constructing trajectory searches the object features through any two search conditions in the face search condition, the body search condition, the vehicle search condition and the identity search condition, and can implement the multi-dimensional search, thereby improving the accuracy and efficiency of the search.

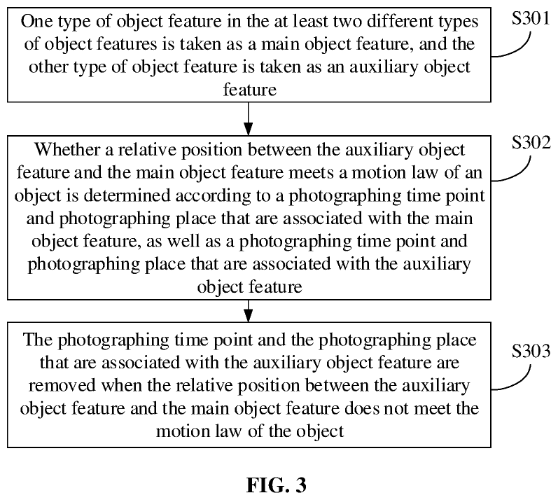

On the basis of operation S102 in the above embodiment, the disclosure further provides still another specific method for constructing object motion trajectory. Specifically, referring to FIG. 3, FIG. 3 is a flowchart of a third embodiment of a method for constructing object motion trajectory provided by the disclosure.

As shown in FIG. 3, the method for constructing object motion trajectory provided by the embodiment may specifically include the following operations.

In S301, one type of object feature in the at least two different types of object features is taken as a main object feature, and the other type of object feature is taken as an auxiliary object feature.

As the face feature is a most expressive feature type among all object features, the device for constructing trajectory sets the face feature as the main object feature, and sets the other type of object feature such as the body feature and the vehicle feature as the auxiliary object feature.

In S302, whether a relative position between the auxiliary object feature and the main object feature meets a motion law of an object is determined according to a photographing time point and a photographing place of the main object feature, as well as a photographing time point and a photographing place of the auxiliary object feature.

Specifically, the device for constructing trajectory acquires adjacent main object feature and auxiliary object feature, calculates a position difference between the photographing place of the main object feature and the photographing place of the auxiliary object feature, and calculates a time difference between the photographing time point of the main object feature and the photographing time point of the auxiliary object feature. Then, the device for constructing trajectory calculates a motion velocity between the main object feature and the auxiliary object feature based on the position difference and the time difference.

In S303, the photographing time point and the photographing place that are associated with the auxiliary object feature are removed if the relative position between the auxiliary object feature and the main object feature does not meet the motion law of the object.

The device for constructing trajectory may preset a motion velocity threshold based on a maximum limit velocity, interval velocity measurement data, historical pedestrian data and the like of the road. When the motion velocity between the main object feature and the auxiliary object feature is more than the preset motion velocity threshold, it is indicated that the main object feature and the auxiliary object feature cannot be normally associated, and thus the photographing time point and the photographing place associated with the auxiliary object feature are removed.

In the embodiment, the device for constructing trajectory determines whether the motion law of the object is met by detecting a relationship between the object features. Thus, the photographing time point and the photographing place associated with the wrong object feature may be removed, thereby improving the accuracy of the method for constructing object motion trajectory.

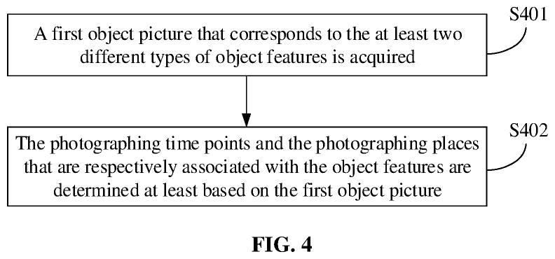

On the basis of operation 5103 in the above embodiment, the disclosure further provides still another specific method for constructing object motion trajectory. Specifically, referring to FIG. 4, FIG. 4 is a flowchart of a fourth embodiment of a method for constructing object motion trajectory provided by the disclosure.

As shown in FIG. 4, the method for constructing object motion trajectory provided by the embodiment may specifically include the following operations.

In S401, a first object picture that corresponds to the at least two different types of object features is acquired.

The device for constructing trajectory acquires the first object picture. The first object picture at least includes the two different types of object features.

Specifically, the device for constructing trajectory acquires an object face image corresponding to the face feature, an object body image corresponding to the body feature and an object vehicle image corresponding to the vehicle feature, respectively. The above images may exist in the same first object picture.

When the object face image, the object body image and/or the object vehicle image exist in the same first object picture, the device for constructing trajectory further associates the object face image with the object body image and/or the object vehicle image according to a preset spatial relationship.

Taking the object face image and the object vehicle image as an example, the preset spatial relationship may include any one of the followings: an image coverage range of the object vehicle image includes an image coverage range of the object face image; the image coverage range of the object vehicle image partially overlaps with the image coverage range of the object face image; or the image coverage range of the object vehicle image links with the image coverage range of the object face image.

In the embodiment, whether the object face image, the object body image and the object vehicle image have an association is determined according to the preset spatial relationship, and thus the relationship among the face, the body and the vehicle can be quickly and accurately recognized. For example, when a driver drives a motor vehicle, the coverage range of the object vehicle image includes the coverage range of the object face image of the driver in the vehicle, and thus the object vehicle image and the object face image have the association and are associated with each other. When a rider rides an electric bicycle, the image coverage range of the object body image of the rider partially overlaps with the image coverage range of the object vehicle image, and thus the object body image and the object vehicle image have the association and are associated with each other.

Optionally, when the at least two different types of object features include the face feature, and after the object face image and the object vehicle image in the first object picture are associated with each other, the device for constructing trajectory acquires, based on the object vehicle image, a second object picture corresponding to the object vehicle image. Optionally, when the at least two different types of object features include the face feature, and after the object face image and the object body image in the first object picture are associated with each other, the device for constructing trajectory acquires, based on the object body image, a third object picture corresponding to the object body image.

The purpose of the acquisition of the second object picture corresponding to the object vehicle image and the third object picture corresponding to the object body image is that: when some object picture does not contain the object face image, the object face image may be searched according to the association as well as the object vehicle image and/or the object body image, so as to enrich trajectory information in the object motion trajectory construction.

In S402, the photographing time points and the photographing places that are associated with the object features respectively are determined at least based on the first object picture.

The device for constructing trajectory determines, based on the first object picture, the second object picture and/or the third object picture, the photographing time points and the photographing places that are associated with the object features respectively.

The disclosure has the following beneficial effects. The device for constructing object motion trajectory acquires at least two different types of object features matching with a search condition, the at least two different types of object features at least including at least two of face features, body features or vehicle features; acquires photographing time points and photographing places that are respectively associated with the at least two different types of object features; and generates an object motion trajectory according to a combination of the photographing time points and the photographing places that are respectively associated with the at least two different types of object features. With the above method, the search condition is inputted to match the corresponding object features, and the object motion trajectory is generated according to the photographing time points and the photographing places that are respectively associated with the object features, thereby improving the practicability of the method for constructing object motion trajectory.

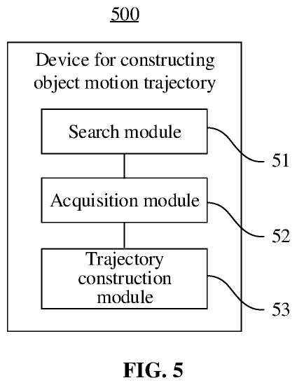

In order to implement the method for constructing object motion trajectory in the above embodiment, the disclosure further provides a device for constructing object motion trajectory. Specifically, referring to FIG. 5, FIG. 5 is a structural schematic diagram illustrating a device for constructing object motion trajectory according to an embodiment provided by the disclosure.

The device 500 for constructing object motion trajectory in the embodiment may be configured to execute or implement the method for constructing object motion trajectory in any of the above embodiments. As shown in FIG. 5, the device 500 for constructing object motion trajectory may include a search module 51, an acquisition module 52 and a trajectory construction module 53.

The search module 51 is configured to acquire at least two different types of object features matching with a search condition, the at least two different types of object features including at least two of face features, body features or vehicle features.

The acquisition module 52 is configured to acquire photographing time points and photographing places that are respectively associated with the at least two different types of object features.

The trajectory construction module 53 is configured to generate an object motion trajectory according to a combination of the photographing time points and the photographing places that are respectively associated with the at least two different types of object features.

In some embodiments, the trajectory construction module 53 is further configured to: take one type of object feature in the at least two different types of object features as a main object feature, and the other type of object feature as an auxiliary object feature; determine, according to a photographing time point and a photographing place of the main object feature, as well as a photographing time point and a photographing place of the auxiliary object feature, whether a relative position between the auxiliary object feature and the main object feature meets a motion law of an object; and remove, if the relative position between the auxiliary object feature and the main object feature does not meet the motion law of the object, the photographing time point and the photographing place that are associated with the auxiliary object feature.

In some embodiments, the trajectory construction module 53 is further configured to: calculate a position difference according to the photographing place of the main object feature and the photographing place of the auxiliary object feature; calculate a time difference according to the photographing time point of the main object feature and the photographing time point of the auxiliary object feature; and calculate a motion velocity based on the position difference and the time difference, and determine, when the motion velocity is more than a preset motion velocity threshold, that the relative position between the auxiliary object feature and the main object feature does not meet the motion law of the object.

In some embodiments, the acquisition module 52 is further configured to: acquire a first object picture that corresponds to the at least two different types of object features; and determine, at least based on the first object picture, the photographing time points and the photographing places that are associated with the object features respectively.

In some embodiments, the acquisition module 52 is further configured to: acquire an object face image corresponding to the face feature, an object body image corresponding to the body feature and/or an object vehicle image corresponding to the vehicle feature, respectively; and associate, when the object face image and the object body image correspond to the same first object picture and have a preset spatial relationship, the object face image with the object body image in the first object picture; associate, when the object face image and the object vehicle image correspond to the same first object picture and have a preset spatial relationship, the object face image with the object vehicle image in the first object picture; and associate, when the object body image and the object vehicle image correspond to the same first object picture and have a preset spatial relationship, the object body image with the object vehicle image in the first object picture.

In some embodiments, when the at least two different types of object features include the face feature, and after the object face image and the object vehicle image in the first object picture are associated with each other, the acquisition module 52 is further configured to: acquire, based on the object vehicle image, a second object picture corresponding to the object vehicle image; and determine, based on the first object picture and the second object picture, the photographing time points and the photographing places that are associated with the object features respectively.

In some embodiments, when the at least two different types of object features include the face feature, and after the object face image and the object body image in the first object picture are associated with each other, the acquisition module 52 is further configured to: acquire, based on the object body image, a third object picture corresponding to the object body image; and determine, based on the first object picture and the third object picture, the photographing time points and the photographing places that are associated with the object features respectively.

In some embodiments, the preset spatial relationship includes at least one of: an image coverage range of a first object associated image includes an image coverage range of a second object associated image; the image coverage range of the first object associated image partially overlaps with the image coverage range of the second object associated image; or the image coverage range of the first object associated image links with the image coverage range of the second object associated image. The first object associated image includes one or more of the object face image, the object body image or the object vehicle image, and the second object associated image includes one or more of the object face image, the object body image or the object vehicle image.

In some embodiments, the search module 51 is further configured to: acquire at least two search conditions; and search object features matching with any search condition in the at least two search conditions from a database.

In some embodiments, the search condition includes at least one of an identity search condition, a face search condition, a body search condition or a vehicle search condition. The object feature is preliminarily associated with identity information, the identity information being any one of identity card information, name information or archival information.

In some embodiments, the search module 51 is further configured to: cluster, with a sample feature of any search condition in the at least two search conditions as a clustering center, object features in the database, and determine object features within a preset range of the clustering center as the object features matching with the search condition.

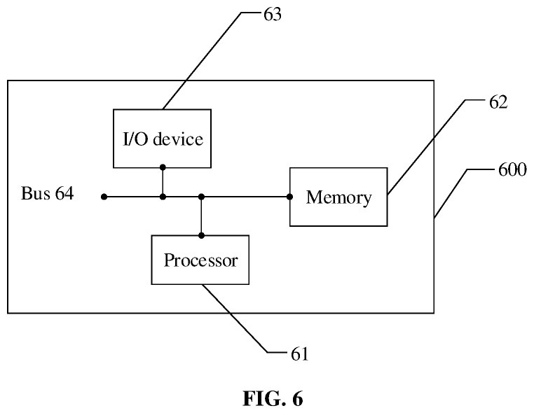

In order to implement the method for constructing object motion trajectory in the above embodiment, the disclosure further provides another device for constructing object motion trajectory. Specifically, referring to FIG. 6, FIG. 6 is a structural schematic diagram of a device for constructing object motion trajectory according to another embodiment provided by the disclosure.

As shown in FIG. 6, the device 600 for constructing object motion trajectory provided by the embodiment may include a processor 61, a memory 62, an Input/Output (I/O) device 63 and a bus 64.

The processor 61, the memory 62 and the I/O device 63 are respectively connected to the bus 64. The memory 62 stores a computer program. The processor 61 is configured to execute the computer program to implement the method for constructing object motion trajectory in the above embodiment.

In the embodiment, the processor 61 may further be called a Central Processing Unit (CPU). The processor 61 may be an integrated circuit chip, and has a signal processing capability. The processor 61 may further be a universal processor, a Digital Signal Processor (DSP), an Application Specific Integrated Circuit (ASIC), a Field Programmable Gate Array (FPGA) or another Programmable Logic Device (PLD), discrete gate or transistor logical device, or discrete hardware component. The processor 61 may further be a Graphics Processing Unit (GPU), also called a display core, a visual processor or a display chip that is a microprocessor specifically performing image operation on a personal computer, a workstation, a gaming machine and some mobile devices (such as a tablet and a smartphone). The GPU is intended to convert and drive display information required by the computer system, and provide a scan signal to the displayer to control correct display of the displayer. It is an important component that connects the displayer to a mainboard of the personal computer, and also one of important devices in “man-machine conversation”. As an important constituent in the host of the computer, the graphics card undertakes the task of outputting and displaying a pattern. The graphics card is very important for people engaged in professional graphic design. The universal processor may be a microprocessor or the processor 61 may also be any conventional processor and the like.

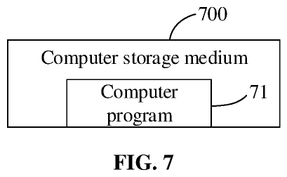

The disclosure further provides a computer readable storage medium. As shown in FIG. 7, the computer readable storage medium 700 is configured to store a computer program 71 which, when being executed by a processor, cause the processor to implement the methods in the embodiments of the method for constructing object motion trajectory provided by the disclosure.

When being realized in form of software functional unit and sold or used as an independent product, the methods in the embodiments of the method for constructing object motion trajectory provided by the disclosure may be stored in a device, such as a computer readable storage medium. Based on such an understanding, the technical solutions of the disclosure substantially or parts making contributions to the conventional art or part of the technical solutions may be embodied in form of software product, and the computer software product is stored in a storage medium, including a plurality of instructions configured to enable a computer device (which may be a personal computer, a server, a network device or the like) or a processor to execute all or part of the steps of the method in each embodiment of the disclosure. The above-mentioned storage medium includes: various media capable of storing program codes such as a U disk, a mobile hard disk, a Read-Only Memory (ROM), a Random Access Memory (RAM), a magnetic disk or an optical disk.

The above are merely some implementations of the disclosure and not intended to limit a scope of the disclosure. Any equivalent structure or equivalent process transformation made according to the specification and accompanying drawings of the disclosure, or direct or indirect utilization in other related technical fields are all included in the scope of protection of the disclosure.

1. A method for constructing object motion trajectory, comprising:
acquiring at least two different types of object features matching with a search condition, wherein the at least two different types of object features comprise at least two of face features, body features or vehicle features;
acquiring photographing time points and photographing places that are respectively associated with the at least two different types of object features; and
generating an object motion trajectory according to a combination of the photographing time points and the photographing places that are respectively associated with the at least two different types of object features.

2. The method of claim 1, wherein generating the object motion trajectory according to the combination of the photographing time points and the photographing places that are respectively associated with the at least two different types of object features further comprises:
taking one type of object feature in the at least two different types of object features as a main object feature, and the other type of object feature as an auxiliary object feature;
determining, according to a photographing time point and a photographing place that are associated with the main object feature, as well as a photographing time point and a photographing place that are associated with the auxiliary object feature, whether a relative position between the auxiliary object feature and the main object feature meets a motion law of an object; and
removing, in response to the relative position between the auxiliary object feature and the main object feature not meeting the motion law of the object, the photographing time point and the photographing place that are associated with the auxiliary object feature.

3. The method of claim 2, wherein determining, according to the photographing time point and the photographing place that are associated with the main object feature, as well as the photographing time point and the photographing place that are associated with the auxiliary object feature, whether the relative position between the auxiliary object feature and the main object feature meets the motion law of the object further comprises:
calculating a position difference according to the photographing place of the main object feature and the photographing place of the auxiliary object feature;
calculating a time difference according to the photographing time point of the main object feature and the photographing time point of the auxiliary object feature; and
calculating a motion velocity based on the position difference and the time difference, and determining, when the motion velocity is more than a preset motion velocity threshold, that the relative position between the auxiliary object feature and the main object feature does not meet the motion law of the object.

4. The method of claim 1, wherein acquiring the photographing time points and the photographing places that are respectively associated with the at least two different types of object features comprises:
acquiring a first object picture that corresponds to the at least two different types of object features; and
determining, at least based on the first object picture, the photographing time points and the photographing places that are respectively associated with the object features.

5. The method of claim 4, further comprising:
after acquiring the first object picture that corresponds to the at least two different types of object features,
acquiring at least one of an object face image corresponding to the face feature, an object body image corresponding to the body feature or an object vehicle image corresponding to the vehicle feature, respectively; and
associating, when the object face image and the object body image correspond to the same first object picture and have a preset spatial relationship, the object face image with the object body image in the first object picture; associating, when the object face image and the object vehicle image correspond to the same first object picture and have a preset spatial relationship, the object face image with the object vehicle image in the first object picture; and associating, when the object body image and the object vehicle image correspond to the same first object picture and have a preset spatial relationship, the object body image with the object vehicle image in the first object picture.

6. The method of claim 5, further comprising:
when the at least two different types of object features comprise the face feature, and after the object face image and the object vehicle image in the first object picture are associated with each other,
acquiring, based on the object vehicle image, a second object picture corresponding to the object vehicle image; and wherein
determining, at least based on the first object picture, the photographing time points and the photographing places that are respectively associated with the object features comprises:
determining, based on the first object picture and the second object picture, the photographing time points and the photographing places that are respectively associated with the object features.

7. The method of claim 5, further comprising:
when the at least two different types of object features comprise the face feature, and after the object face image and the object body image in the first object picture are associated with each other,
acquiring, based on the object body image, a third object picture corresponding to the object body image; and wherein
determining, at least based on the first object picture, the photographing time points and the photographing places that are respectively associated with the object features comprises:
determining, based on the first object picture and the third object picture, the photographing time points and the photographing places that are respectively associated with the object features.

8. The method of claim 5, wherein
the preset spatial relationship comprises at least one of: an image coverage range of a first object associated image comprises an image coverage range of a second object associated image; the image coverage range of the first object associated image partially overlaps with the image coverage range of the second object associated image; or the image coverage range of the first object associated image links with the image coverage range of the second object associated image,
the first object associated image comprises one or more of the object face image, the object body image or the object vehicle image, and the second object associated image comprises one or more of the object face image, the object body image or the object vehicle image.

9. The method of claim 1, wherein acquiring the at least two different types of object features matching with the search condition comprises:
acquiring at least two search conditions; and
searching object features matching with any search condition in the at least two search conditions from a database.

10. The method of claim 9, wherein the search condition comprises at least one of an identity search condition, a face search condition, a body search condition or a vehicle search condition,
wherein the object feature is preliminarily associated with identity information, the identity information being one of identity card information, name information or archival information.

11. The method of claim 9, wherein searching the object features matching with any search condition in the at least two search conditions from the database comprises:
clustering, with a sample feature of the any search condition in the at least two search conditions as a clustering center, object features in the database, and determining object features within a preset range of the clustering center as the object features matching with the search condition.

12. A device for constructing object motion trajectory, comprising:
a processor; and
a memory for storing a computer program,
wherein the processor is configured to execute the computer program to:
acquire at least two different types of object features matching with a search condition, wherein the at least two different types of object features comprise at least two of face features, body features or vehicle features;
acquire photographing time points and photographing places that are respectively associated with the at least two different types of object features; and
generate an object motion trajectory according to a combination of the photographing time points and the photographing places that are respectively associated with the at least two different types of object features.

13. The device for constructing object motion trajectory of claim 12, wherein the processor is further configured to:
take one type of object feature in the at least two different types of object features as a main object feature, and the other type of object feature as an auxiliary object feature;
determine, according to a photographing time point and a photographing place that are associated with the main object feature, as well as a photographing time point and a photographing place that are associated with the auxiliary object feature, whether a relative position between the auxiliary object feature and the main object feature meets a motion law of an object; and
remove, in response to the relative position between the auxiliary object feature and the main object feature not meeting the motion law of the object, the photographing time point and the photographing place that are associated with the auxiliary object feature.

14. The device for constructing object motion trajectory of claim 13, wherein the processor is further configured to:
calculate a position difference according to the photographing place of the main object feature and the photographing place of the auxiliary object feature;
calculate a time difference according to the photographing time point of the main object feature and the photographing time point of the auxiliary object feature; and
calculate a motion velocity based on the position difference and the time difference, and determine, when the motion velocity is more than a preset motion velocity threshold, that the relative position between the auxiliary object feature and the main object feature does not meet the motion law of the object.

15. The device for constructing object motion trajectory of claim 12, wherein the processor is further configured to:
acquire a first object picture that corresponds to the at least two different types of object features; and
determine, at least based on the first object picture, the photographing time points and the photographing places that are respectively associated with the object features.

16. The device for constructing object motion trajectory of claim 15, wherein the processor is further configured to:
acquire at least one of an object face image corresponding to the face feature, an object body image corresponding to the body feature or an object vehicle image corresponding to the vehicle feature, respectively; and
associate, when the object face image and the object body image correspond to the same first object picture and have a preset spatial relationship, the object face image with the object body image in the first object picture; associate, when the object face image and the object vehicle image correspond to the same first object picture and have a preset spatial relationship, the object face image with the object vehicle image in the first object picture; and associate, when the object body image and the object vehicle image correspond to the same first object picture and have a preset spatial relationship, the object body image with the object vehicle image in the first object picture.

17. The device for constructing object motion trajectory of claim 16, wherein the processor is further configured to: when the at least two different types of object features comprise the face feature, and after the object face image and the object vehicle image in the first object picture are associated with each other,
acquire, based on the object vehicle image, a second object picture corresponding to the object vehicle image; and
determine, based on the first object picture and the second object picture, the photographing time points and the photographing places that are respectively associated with the object features.

18. The device for constructing object motion trajectory of claim 16, wherein the processor is further configured to: when the at least two different types of object features comprise the face feature, and after the object face image and the object body image in the first object picture are associated with each other,
acquire, based on the object body image, a third object picture corresponding to the object body image; and
determine, based on the first object picture and the third object picture, the photographing time points and the photographing places that are respectively associated with the object features.

19. The device for constructing object motion trajectory of claim 12, wherein the processor is further configured to:
acquire at least two search conditions; and
search object features matching with any search condition in the at least two search conditions from a database.

20. A non-transitory computer readable storage medium having stored therein a computer program which, when being executed by a processor, causes the processor to implement operations comprising:
acquiring at least two different types of object features matching with a search condition, wherein the at least two different types of object features comprise at least two of face features, body features or vehicle features;
acquiring photographing time points and photographing places that are respectively associated with the at least two different types of object features; and
generating an object motion trajectory according to a combination of the photographing time points and the photographing places that are respectively associated with the at least two different types of object features.
